(19) United States
(12) Patent Application Publication
(10) Pub. No.: US 2004/0073558 A1
(43) Pub. Date: Apr. 15, 2004

(54) Method and apparatus for providing an automated information management for high throughput screening

(76) Inventors: Tom Amandus Jozef Schrijvers, Herent (BE); Jozef Pieter Jan Lambrechts, Diepenbeek (BE); Ronnie Eddy Leo Alfons De Fosse, Kortenberg (BE); Rudi Wilfried Jan Pauwels, Bonheiden (BE)

Correspondence Address: PHILIP S. JOHNSON, JOHNSON & JOHNSON, ONE JOHNSON & JOHNSON PLAZA, NEW BRUNSWICK, NJ, 08933-7003, US

(21) Appl. No.: 10/467,885

(22) PCT Filed: Feb. 13, 2002
(86) PCT No.: PCT/EP02/01673

(30) Foreign Application Priority Data
Feb. 14, 2001 (EP) 01200526.0

(51) Int. Cl. G06F 7/00

(52) U.S. Cl. 707/100

(57) ABSTRACT

The present invention relates to a computer-implemented method for managing information relating to a high throughput screening (HTS) process and to apparatuses or robot means controlled by said method. A database model is provided which organizes information relating to analytes, biological targets, HTS supports, HTS conditions, interaction results, robotics steering and control, etc.

### FIELD OF THE INVENTION

The present invention relates to a computer-implemented method for managing information relating to a high-throughput screening (HTS) process and to apparatuses or robot means controlled by said method.

### BACKGROUND OF THE INVENTION

The main object of HTS is to discover new leads or information e.g. chemical or biological activities of analytes or compounds, which can further be developed into pharmaceutical agents.

Although there is considerable scope for rational drug design, there is a major requirement for empirical screening owing to the limited knowledge of the required interaction between an analyte and a biological target. Since the chemical starting point for lead optimization cannot be ascertained, the basic premise with HTS is to screen a chemically diverse and large set of analyte samples with the aim of identifying a lead analyte, which in the majority of cases needs to be optimized for potency and/or selectivity. The 96-well microplate has found widespread application as a suitable support unit for HTS although recently microplates of 384 well format have become available.

The number of combinations and permutations on these supports, combined with the number of analytes and potential test samples would overwhelm any biochemist or traditionally automated system attempting to perform an exhaustive HTS.

Several computer implemented methods for managing HTS-process information are known. Most automated lab systems have software that takes care of scheduling samples through the system. The technician sets up the scientific method to be executed. These methods denote the exact steps that are to be performed on a single sample. A technician then executes a scheduling algorithm on a particular number of samples which determines the sample step interleaving. These scheduler must balance the load, prevent deadlocks and enforce resource use and availability.

Automated lab systems today are known as Laboratory Information Management Systems (LIMS). LIMS typically involve the integration of automated robots into a central computing system allowing for control of the processes of each work-unit involved. An example of such a LIMS is described in U.S. Pat. No. 5,985,214 wherein a system and a method for rapidly identifying chemicals in liquid samples is described. The system focuses on the rapid processing of addressable sample wells or the routing of these addressable wells.

LIMS typically include sample automation and data automation. Sample automation primarily involves control of robotics processes, routing of samples and sample tracking. Data automation typically involves generation of data accumulated from a wide variety of sources. WO 99/05591 describes a system and method for organizing information relating to polymer probe array chips whereby a database model is provided which organizes information relating to sample preparation, chip layout, application of samples to chips, scanning of chips, expression analysis of chip results, etc. This system models the specific high throughput entities as if the testing would be performed manually.

Laboratories want to increase throughput, reduce the use of time, labour and consumables such as analytes, targets and support plates, increase reliability and reduce complexity. Known systems have not succeeded in managing the process information as a whole and still require substantial manual manipulation and control.

Consequently there is a need to provide an intelligent automated information management systems, which system is able to control in real time the information obtained throughout the whole HTS process and at the same time is able to control and to steer the complete HTS.

The main object of the present invention is to provide a method and apparatus providing an automated information management for a HTS process wherein a minimal manual interaction of the technician is required. The invention provides therefor a combined method in which a LIMS is actively linked to the HTS robotics.

### SUMMARY OF THE INVENTION

The present invention provides a automated information management system and method relating to HTS. A data base model is provided which organizes information relating to analytes, biological targets, HTS supports, HTS conditions, interaction results, robotics steering and control, etc. In a preferred embodiment the model is exemplified in SQL data language in an Oracle environment.

According to a first aspect of the present invention a computer implemented method is provided for managing information relating to a high throughput process modeled in one logical database, said method comprising the steps of:

a) creating, in any order,

(i) instances for a analyte A entity, whereby said entity comprises a analyte A identifier,

(ii) instances for a support entity, whereby said entity comprises a support identifier,

(iii) instances for an assay entity, whereby said entity comprises an assay identifier,

(iv) instances for a protocol entity, whereby said entity comprises a protocol identifier,

b) creating

(i) instances for a analyte A on a first support entity, whereby said entity comprises a analyte A on support identifier, the analyte A identifier, the support identifier and a coordinate identifier,

(ii) instances for a first robot move entity, whereby said entity comprises the analyte A on support identifier, and

c) creating

(i) instances for an experiment entity, whereby said entity comprises an experiment identifier, the assay identifier, the analyte A on support identifier and the protocol identifier, whereby said experiment entity comprises instances whereby the analyte A entity is related to the assay entity, and

(ii) instances for a second robot move entity, whereby said entity comprises the experiment identifier.

A preferred embodiment of the method further comprises after step b) an iteration of the steps a) (i) and b) on a second support entity, which has an integer multiple of the number of coordinates of the previous support entity.

Another preferred embodiment of the method includes the step of creating instances for a result entity, whereby said entity comprises a result identifier and the experiment identifier.

Yet another preferred embodiment of the method includes the step of creating instances for an assay entity whereby the assay entity comprises instances for a target B entity, whereby said target B entity comprises a target B identifier.

Yet another preferred embodiment of the method includes the creation of instances for an experiment entity by

a) first creating an entity comprising an identifier for said entity, the analyte A on a support identifier and the protocol identifier, and

b) then, creating the experiment entity comprising the experiment identifier,

the identifier for the entity created in step a), and an assay identifier; and whereby the instances for a second robot move entity involve the application of target B as defined within the assay identifier, on the analyte A on the support as defined in the analyte A on a support identifier.

According to a second aspect of the invention the method includes a reporting facility reporting the result instances for one support identifier with the corresponding instance(s) from the experiment entity.

According to a third aspect of the invention a HTS device is provided under the control of the method of the present invention.

According to a fourth aspect a specific compact embodiment of the complete HTS device is provided. In this preferred embodiment the dimension of the computer system and the robots and/or robots of the high throughput screening system are such that said HTS device as a whole is transportable in a working status on the public road. Said HTS device is preferably designed to fit into a 20 foot and/or a 40 foot container.

In a fifth aspect the automated control of the entire process by means of the computer system linked to the internet is provided for allowing long-distance access, whereby an experiment can be scheduled, processed, analyzed and reported without the direct presence at the experiment site of a scientist or a technician. This is an important aspect in the testing of for example biohazardous compounds.

### BRIEF DESCRIPTION OF THE DRAWINGS

FIG. 1 is a schematic overview of a high throughput process according to the present invention.

FIG. 2 is a schematic overview of an embodiment of a high throughput process according to the present invention.

FIG. 3 is a process-flow of the embodiment of FIG. 2.

FIG. 4 is a schematic overview of a computer network for the embodiment of FIG. 2.

FIG. 5a,b and c are examples of relationships within an ERD.

FIG. 6 is an ERD of an embodiment according to the present invention.

FIG. 7 is a logical model according to the present invention.

### DETAILED DESCRIPTION OF THE INVENTION

The present invention provides a computer-implemented method for managing information relating to a high throughput process.

A high throughput screening process according to the invention is any process wherein new information is generated regarding chemical or biological activities of chemical or biological entities.

In the present invention HTS is described relating to the interaction of an analyte A with a target B. Analyte A is in general a chemical and/or biological compound or composition, target B is in general a chemical and/or biological compound and/or a physical entity.

In HTS drug discovery the analyte A is in general a chemical compound and the target B is generally a biological medium in which the performance of the analyte for a specific activity is screened.

The analyte A is available in a pharmacy library and is preferably selected from chemical compounds, antigens, antibodies, polypeptides, proteins, DNA and RNA sequences, DNA-probes, cells and beads and liposomes comprising the analyte of interest or a combination thereof. Target B can be the same or a different kind of component as the analyte A and is in general a biological cell medium optionally provided with marker means. The A-B interactions are in general measured using one or more of the following methods: fluorometric, luminometric, densitometric, isotropic, and physical measurement.

Computer-implemented Method for Managing Information

Managing information relating to a high throughput process is a primary aspect of the present invention. Process information involves for instance information about the support, the analytes A applied on the support, the targets B added to the analytes A, the interaction conditions, the robot and robot move entities.

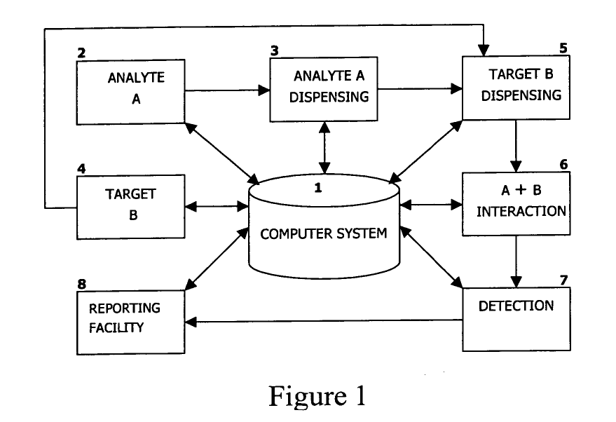

FIG. 1 is a schematic overview of an automated high throughput screening laboratory, comprising one or more high throughput robots (2-8), bi-directionally linked to a computer system 1 that controls said robots and is able to manage information relating to the high throughput process. Information management within the computer system and the high throughput screening system is preferentially bi-directional: with each step within the high throughput screening system information is collected, stored in the computer system and processed accordingly, information is sent to the robot entities from the computer system for example in the form of process commands or as a control step, whereby an expected result is compared with the obtained result. This correlation is an essential feature of the invention in order to minimize manual interference. A control check step is introduced whenever a new result or new information is obtained. Specific information may also be requested by the robots. Such requested information may be for example scheduling information, when an robot is idle and requests a job. Another example is result information requested by a scientist via a user interface.

A robot entity is a dedicated robot to perform a task or multiple tasks. An example of a robot is the robot 3 for dispensing an analyte A on a support plate. Another example of a robot entity is a robot 5 for dispensing a target B on the support which was already provided with analytes A. Other examples of a robot entity are the computer-controlled incubation unit 6 and the computer-controlled detection unit 7. Another example of a robot entity is a robot 2 for storage and retrieval of analytes A and a robot 4 for storage and retrieval of targets B.

A reporting facility 8 is linked to the computer system via a user interface for consulting the information in the computer system relating to the results of a high throughput process. All the robot entities (2-8) are bi-directionally linked to the computer system.

Other examples of robot entities that can be linked to the computer system is an inventory system, an environment management system and the like. In one embodiment only a number of high throughput robots are linked to the computer system. In a preferred embodiment all high throughput robots involved in the high throughput process are linked to the computer system.

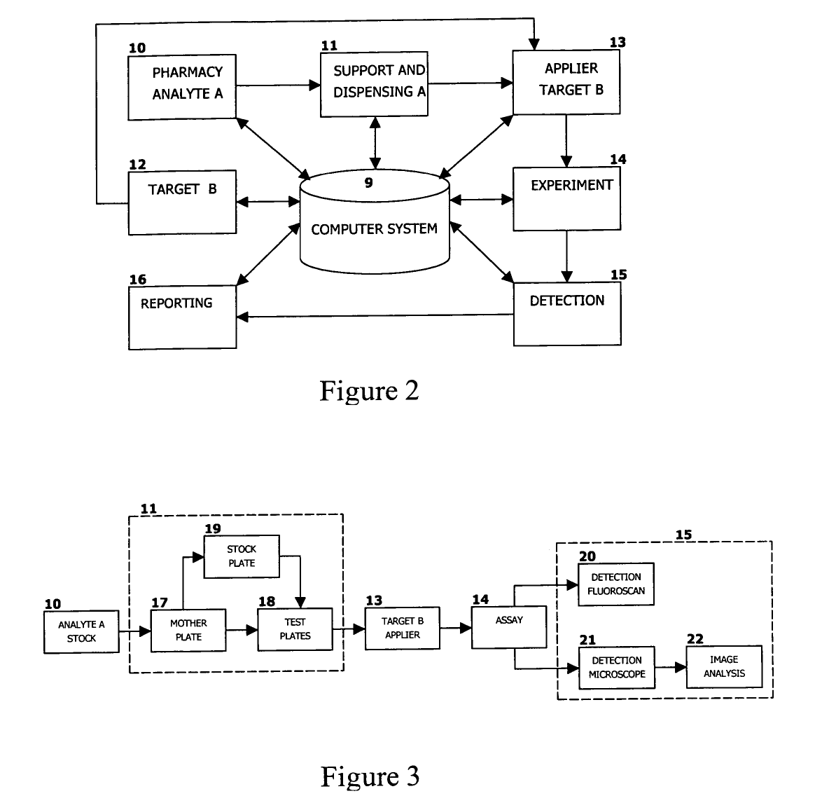

FIG. 2 is a schematic overview of a specific embodiment of a high throughput screening process according to FIG. 1 for drug discovery.

The computer system 9 is fed with initial information relating to an experiment to be performed or the computer calculates the free time and suggests autonomously the kind and the number of experiments to be performed. This is done either by a biochemist via a user interface, but this may also be the result of an automatic tool for setting up experiments. Such an automatic tool can be a knowledge based system or an expert system defining new experiments from previously processed experiments, or defining new experiments from knowledge built up by biochemist experience, or any other combination of prescience.

Initial experiment information concerns the analytes A to be used, for example concentration and volume. This information is related to the pharmacy stock 10.

Initial experiment information also concerns the support on which the analytes A will be applied, for example type of support. Each support comprises a number of coordinates (in general X, Y-coordinates) identifying a precise position on the support. In general these supports are of the well-type defining a precise position of each analyte A on the support. This information is related to the plate design and the used liquid handling system such as dispensing system 11.

Other initial experiment information concerns the assay that needs to be done. The assay information primarily comprises two types of information, ie meta information on the assay and information on the target B to be added to the analytes A, for example information about the concentration, volume, optional patient-code and biohazard. This target B information is related to the target B storage system 12 and to the applier or dispensing system 13. In general for drug discovery the target B is a biological cell medium which is applied on all the analytes A in one support.

Concerning the experiment system 14, information is needed about the interaction conditions, such as temperature, humidity and time.

The detection system 15 needs to know how the assay scanning should be done. When using cell-based assays for example, one or more images per well have to be taken and these images have to be analyzed subsequently.

The initial setup information is sent from the computer system to the robots. Robots may also request this information themselves.

A scheduling algorithm is running within the computer system to program the processes in time, ensuring efficient robot allocation, according to the steps to be performed and the time necessary to perform these steps. The scheduling algorithm can be a batch program continuously looking for tasks to be scheduled. It can also be an interactive program where scheduling tasks can be altered manually by a technician. A task to be scheduled concerns an initial setup to be defined. A schedule task also concerns the start and stop time of a robot or the program to be performed by the robot. This scheduling information is sent from the computer system to the robots 10-16. Robots can also request this information themselves. It is self-evident that if for the latter is provided a security check is performed by a technician.

After initial experiment setup is defined, and every robot within the high throughput screening process is scheduled and knows what to do, the actual process can take place. The pharmacy stock 10 is scheduled as to make sure that the analytes A are available for use at the time they are needed. Information concerning this process is sent back to the computer system, for example when a analyte A is not available. This information needs to be reported to the computer system in order to postpone the process and reschedule.

Every action performed by a robot is passed to the computer system, whereby the computer system performs a double check whether the process went as planned and whether it was performed correctly. Planning information can be tested in accordance to a predetermined schedule; correctness can be checked using control experiments of which the expected result is known beforehand and can be checked with the actual result fed back to the computer system. Each robot feeds information back to the computer system, which controls said received information. If said control results in an unexpected value a warning signal can be provoked to the technician. As this warning signal occurs, the technician can restore the HTS system with or without the help of the computer system.

After the computer system decided that the pharmacy system performed its task correctly, the plate design and filler process 11 will apply the analytes A delivered by the compounds stock system 10 onto a support ready for experiment. In one preferred embodiment this involves an intermediate step of starting from a mother support comprising 96 wells filled with analytes A and multiplying said mother support a number of times as to form the actual experiment support. This intermediate task is also scheduled appropriately.

The support design system feeds information back into the computer system, whereby it again is double-checked for possible errors.

The dispensing system 13 adds the targets B prepared in system 12 to the analytes A on the support. Again, information is fed back to the computer system and the process step is double-checked.

The experiment 14 takes place when analyte A and B are allowed to interact whereafter information is fed back to the computer system.

A detection system 15 sends a detection signal in the form of an image or data of the detected interaction activity back to the computer system. This information is preferably stored for further processing, for example image analysis.

The reporting system 16 presents the results of the experiments. Interaction result images are presented as well as the raw data comprised within the computer system. The computer system is queryable for any information concerning previous experiments, as well as future initial experiment setups. This querying is called data mining. The reporting and data mining system will be discussed more in detail further.

Information about every step of the process is accessible at all times before, during and after the process. It is obvious that before the process takes place, information is only available about the initial experiment setup and possibly about the schedule (also compound information). Information is accessible at real-time by any robot. This robot can be a user interface processed by a biochemist mining the computer system for relevant information concerning a specific compound. Again all robots 10-16 may be bi-directionally linked to the computer system 9.

In one embodiment, the robots linked to the computer system are incorporated in one robot. In another embodiment, the robots are physically different robots, whereby the support comprising the target A and target B is transported accordingly from one robot to another. The transport itself is an robot linked to the computer system and scheduled accordingly.

One embodiment of a high throughput process according to the present invention is represented in FIG. 3 as a process flow. A pharmacy stock 10 stores the analytes A in large volumes. A first filler system applies small volumes of analytes A onto a well support, the mother-plate. The test-plate 18 is a support comprising the analytes A to be tested during an experiment. The test-plate 18 is derived from a mother-plate 17 by means of an intermediate stock-plate 19. Said stock-plate is used to generate one or more test-plates 18. The test-plate 18 has a multitude of wells or positions for the analyte A.

In one embodiment the filler system 11 is described in the prior filed not yet published patent application EP00203083.1 wherein a system for preparing a matrix of filled capillaries is disclosed comprising:

a loader configured to load a plurality of unfilled capillaries onto a first transporter;

a manipulator configured to collect the plurality of unfilled capillaries from the first transporter, fill the capillaries with a solution, and load the filled capillaries onto a second transporter; and

a stacker configured to collect the filled capillaries from the second transporter and feed the filled capillaries onto a matrix template.

The filler system comprises a step whereby a support comprising 96 analytes A is multiplied to a support preferably comprising 384, 1536, or 9600, or any other multiplicand of 96 analytes A via the intermediate stock-plate 19.

In another preferred embodiment the filler system comprises a dispensing apparatus as disclosed in PCT/IB98/01399 wherein a method for the rapid screening of analytes is disclosed, comprising the steps of:

a) simultaneously applying a plurality of analytes to be screened onto one or more solid support(s) such that the analytes remain isolated from one another;

b) contacting said analyte-carrying solid support(s) with targets provided in a semi-solid or liquid medium, whereby said analytes are released from the solid support(s) to the targets; and

c) measuring analyte-target interactions.

After preparing the test-plate 18, a target B is added to the analytes A by means of a target B dispensing system 13.

In one embodiment a “phase applier” system 15 is used as described in the prior filed not yet published patent application EP00200813.4, in which a method is disclosed for introducing a predetermined quantity of fluid from a reservoir, through a fluid outlet in fluid communication with said reservoir, into at least one series of adjoining wells of a multi-well plate, characterized in that for introducing said predetermined quantity of fluid in said series of wells, said fluid outlet is moved relative to the multi-well plate so that it passes in a continuous movement over said series of wells and during this passing an uninterrupted flow of said fluid is dispensed out of the fluid outlet.

During the actual experiment 14, AB interaction is allowed. In general an incubation system is used to perform the experiment in the appropriate interaction conditions.

A detection system 15 detects the activity of an AB interaction. Activity includes for example turbulence, fluorescence, crystallization, . . . In one embodiment AB interaction is detected by a fluoroscan 20. In a preferred embodiment AB interaction is detected by means of a microscope 21. Image analysis means 22 are used to analyze the microscopic scan.

In a preferred embodiment the microscope 21 is an auto-focussed microscope as described in the prior filed not yet published patent application U.S. Ser. No. 09/521,618 wherein an apparatus is disclosed for automatically focusing an image of an object plane in a microscope, comprising:

an optical system configured to form an image of an object plane to be observed, said optical system comprising:

an objective lens configured to focus on the object plane, an illumination beam source for illuminating the object plane with an illumination light beam, and

an image lens configured to create an image of the object plane;

an auto-focusing detection system comprising:

an auto-focusing light beam source for generating an auto-focusing light beam, a beamsplitter configured to direct the auto-focusing light beam to the object plane and cause the auto-focusing light beam to reflect off the object plane, a detection system lens configured to direct the reflected auto-focusing light beam to an auto-focusing detection device, and

an auto-focusing detection device for determining the amount of displacement of the image of the object plane in the optical system from a desired focused reference plane based on the detected displacement of an image plane of the reflected auto-focusing light beam from a predetermined reference plane in the auto-focusing detection system, said auto-focusing detection device comprising at least one sensor for sensing the reflected auto-focusing light beam and detecting the displacement of the image plane; and

a focusing correction system comprising a feedback controller and focus adjusting device for automatically adjusting the distance between the objective lens and the object plane, based on the reflected auto-focusing light beam sensed by said at least one sensor, in order to properly focus the image in the optical system.

The four patent applications mentioned above are hereby enclosed by reference. It is possible to miniaturize the complete HTS system including the computer system such that it is transportable on public traffic roads. In particular when the four previously defined robots are included, dimensions smaller than or equal to a 20 or 40 foot container are possible.

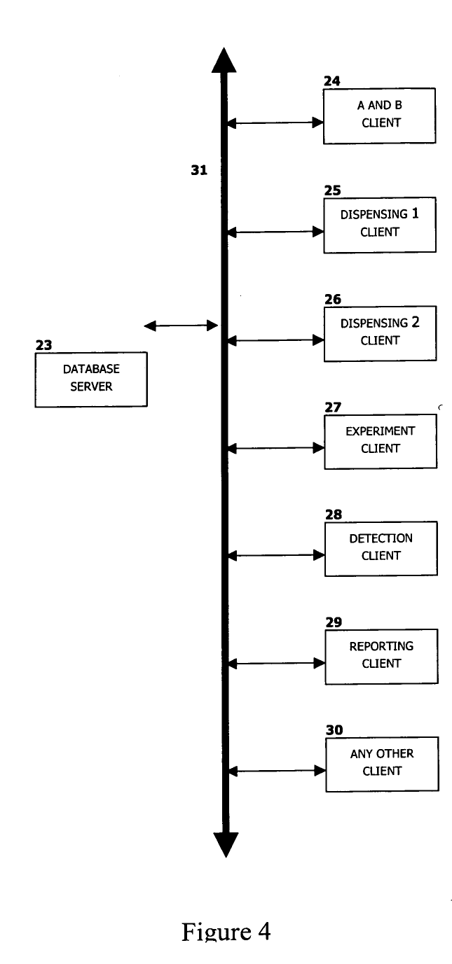

FIG. 4 represents a computer network for integrating the information management system of FIG. 1. In a preferred embodiment the computer system is a database server 23 connected to clients 24-30. The clients are the robots, whereby robots are to be interpreted broadly as any robot system or any other system linkable to a computer system. Each robot has an interface whereby the robot is connected to the central computing system. Via this interface all relevant information related to the specific robot can be managed in the database server.

Logical Model

In the present invention a high throughput system is modeled in one logical database. This means that the process as a whole is understood by the computer system as being one logical process, even if the actual sub-processes are being performed on different robots and even if the information is being stored on different computer systems. The high throughput process model is implemented in one or more database systems.

In a preferred embodiment an Oracle relational database system is used to model the entire process. The logical model can also be implemented in an object-oriented database.

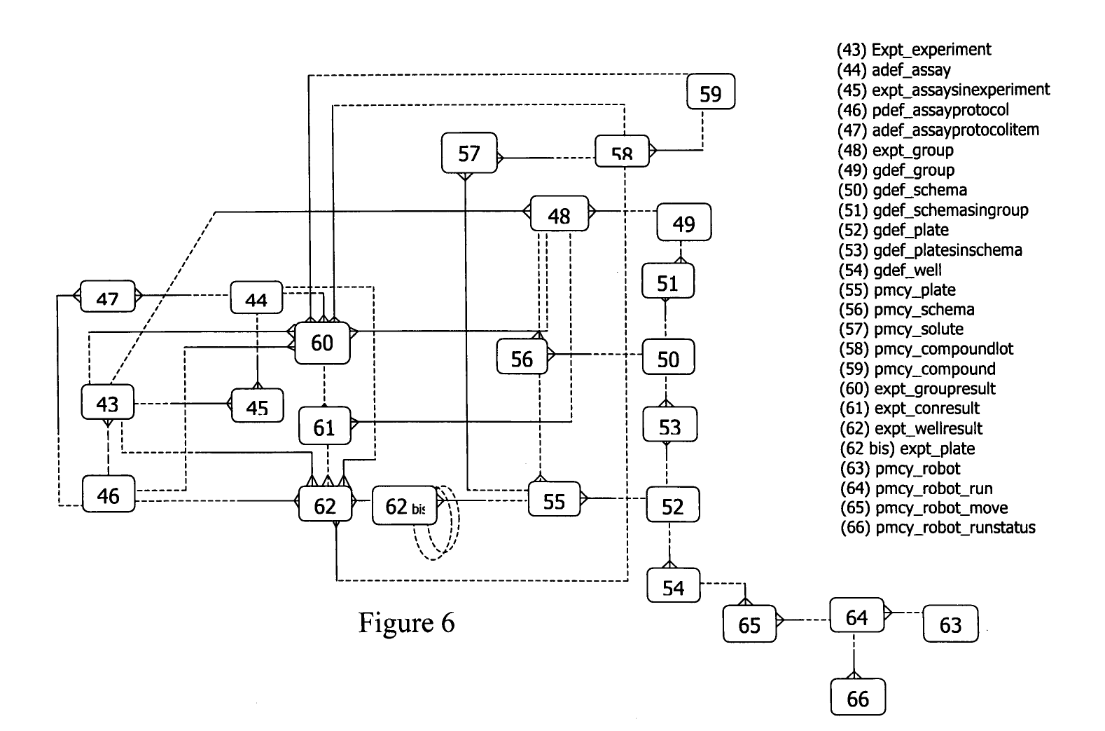

FIG. 6 represents an Entity Relationship Diagram (ERD) according to the computer-implemented method of the present invention. Those skilled in the art will appreciate that automated tools such as Oracle Developer 2000 will convert the ERD directly into executable code such as SQL code for creating and operating the database.

Each rectangle in the diagram corresponds to a logical unit in the database, called an entity. An entity corresponds to a table in the database. The name of the entity is listed in the rectangle.

Each entity has one or more characteristics, called the attributes. An attribute corresponds to a field or a column in a table. In the claims an attribute is referred to as an identifier. An attribute is mandatory or optional. An optional attribute may have a value that is not specified in the instance. This is called a null-value. A mandatory attribute must always have a value in an instance.

The attribute that uniquely identifies each instance of an entity is called the primary key. The primary key can also consist of more than one attribute. Attributes defining the primary key are mandatory.

Each entity comprises one or more instances. An instance corresponds to a row or a record in a table. An instance is a set of values for the attributes of an entity.

The lines between the rectangles represent associations between entities, called relationships. Each relationship has a cardinality. This is the number of instances of one entity that can or must be associated with another entity.

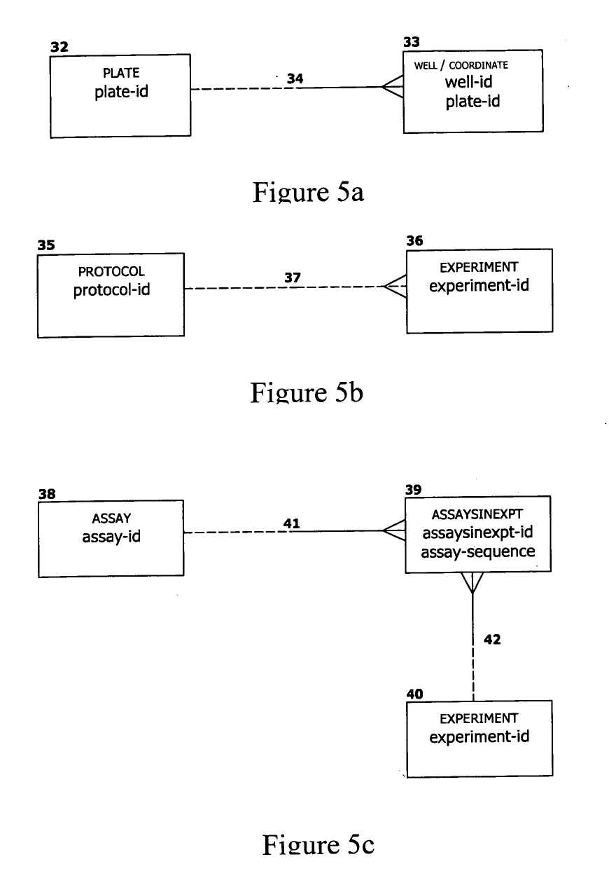

FIG. 5a represents an example ERD. The ERD models a plate entity 32 and a well entity 33. The plate entity 32 models the physical plate support in a high throughput system; the well entity 33 models the wells or identifiable positions in such a support having a specific coordinate. The relationship 34 is interpreted as follows: each plate instance is associated to, or have, zero, one or more wells; each well instance is associated to, or belongs to, one plate. For each plate instance there can be one or more well instances; for each well instance there must be one plate instance.

This means that a plate, for example a flat support plate, can have one or more wells; a microtiterplate for example has 96 wells. The 96 wells belong to one and the same microtiterplate. The plate entity 32 is uniquely identified by a plate-id. The well entity 33 is uniquely identified by a well-id and a plate-id. The relationship of FIG. 5a will further be referred to as a common one-to-many relation between a first entity and a second entity, whereby in this example the first entity is the plate entity 32 and the second entity is the well entity 33.

The plate-id of the well entity 33 is a so-called foreign key. A foreign key is a field in an entity where that field is a primary key of another entity. FIG. 6 does not mention foreign keys explicitly.

FIG. 5b illustrates a one-to-many relation between a protocol entity 35 and an experiment entity 36, whereby a protocol may be used for a plurality of experiments, and whereby an experiment may be done using one protocol. The relationship of

FIG. 5b will be referred to as an optional one-to-many relation between a first entity and a second entity, whereby in this example the first entity is the protocol entity 35 and the second entity is the experiment entity 36.

FIG. 5c represents another example ERD. The ERD models an assay entity 38 and an experiment entity 40. The assay entity 38 models the assays, including targets B, as described earlier. The experiment entity 40 models an experiment or an interaction between a analyte A and a target B. A third entity assaysinexpt 39 creates a tertiary relationship between the said two entities. The assaysinexpt entity 39 models the assays involved in an experiment. Each assay in the experiment has an assay-sequence.

There is a one-to-many relationship 41 between the assay entity 38 and the assaysinexpt entity 39, meaning that for each assay instance there are zero, one or more assaysinexpt instances; for each assaysinexpt instance there is one assay instance. There is a one-to-many relationship 42 between the experiment entity 40 and the assaysinexpt entity 39, meaning that for each experiment instance there are zero, one or more assaysinexpt instances; for each assaysinexpt instance there is one experiment instance. An assay instance may be involved in a plurality of experiments. An experiment instance may involve a plurality of assays, whereby each assay within the experiment is identified by an assay-sequence. Each assay-sequence within an experiment must always relate to just one assay and to just one experiment. The relationship of FIG. 5c will further be referred to as a many-to-many relation between two entities through a third entity, whereby in this example the two entities are the assay entity 38 and the experiment entity 40 through an assaysinexpt entity 39.

Database Model

The logical data-model of FIG. 6 will be explained more in detail hereafter.

An expt_experiment entity 43 lists experiments performed on assays using a group of plates and may be done according to a protocol.

Assays are listed in an adef_assay entity 44 and linked to the expt_experiment entity 43 in a many-to-many relation through an expt_assaysinexperiment entity 45. The expt_assaysinexperiment entity 45 lists the assays involved in an experiment. Each assay within an experiment has an assay sequence.

Protocols are listed in a pdef_assayprotocol entity 46 by an optional one-to-many relation between the pdef_assayprotocol entity 46 and the expt_experiment entity 43. A protocol may be used for a plurality of experiments. If an experiment is done according to a protocol, the experiment is linked to only one protocol. The pdef_assayprotocol entity 46 is linked to the adef_assay entity 44 by a many-to-many relation through a pdef_assayprotocolitem entity 47. The pdef_assayprotocolitem entity 47 lists assays used in a protocol.

The groups of plates used in the experiment are listed in a expt_group entity 48. A one-to-many relation is defined between the expt_experiment entity 43 and the expt_group entity 48. The expt_group entity 48 lists the physical supports already applied with analytes A used in an experiment.

A gdef_group entity 49 lists abstract groups of physical supports, whereby abstract means containing all meta information about the groups. The characteristics of a physical support are typically related to layout characteristics such as type, shape, number of wells. The gdef_group entity 49 is linked to a gdef_schema entity 50 by a many-to-many relation through a gdef_schemasingroup entity 51, whereby each schema in a group has a schema sequence id. The gdef_schema entity 50 is linked to a gdef_plate entity 52 by a many-to-many relation through a gdef_platesinschema entity 53, whereby each plate in a schema has a plate sequence id. A one-to-many relation is defined between the gdef_plate entity 52 and a gdef_well entity 54. The gdef_well entity 54 lists the wells in a plate. Each well has a column and a row position. Thus, plates can have wells; plates are grouped in schemas whereby each schema has a number of plates; schemas are further grouped in groups, whereby each group has a number of schemas.

The general definition for a physical support is further used to model a analyte A applied on a physical support. A one-to-many relation is defined between the gdef_plate entity 52 and a pmcy_plate entity 55. A similar one-to-many relation is defined between the gdef_schema entity 50 and a pmcy_schema entity 56. A similar one-to-many relation is defined between the gdef_group entity 49 and the expt_group entity 48. An optional one-to-many relation is defined between the pmcy_schema entity 56 and the pmcy_plate entity 55. An optional one-to-many relation is defined between the expt_group entity 48 and the pmcy_schema entity 56. Again plates are grouped in schemas and schemas are further grouped in groups, but now this involves applied supports, meaning that pharmacy compounds or analytes A have been applied onto the supports.

A one-to-many relation is defined between the pmcy_plate entity 55 and a pmcy_solute entity 57. The pmcy_solute entity 57 lists pharmacy compound solutions. A one-to-many relation is defined between a pmcy_compoundlot entity 58 and the pmcy_solute entity 57. The pmcy_compoundlot entity 58 lists compound-lots. A one-to-many relation is defined between a pmcy_compound entity 59 and the pmcy_compoundlot entity 58. The pmcy_compound entity 59 lists pharmacy compounds.

An expt_groupresult entity 60 lists results relating to experiments performed on assays using a group of plates and done according to a protocol. A one-to-many relation is defined between the expt_experiment entity 43 and the expt_groupresult entity 60. A one-to-many relation is defined between the adef_assay entity 44 and the expt_groupresult entity 60. A one-to-many relation is defined between the pdef_assayprotocol entity 46 and the expt_groupresult entity 60. A one-to-many relation is defined between the expt_group entity 48 and the expt_groupresult entity 60. A one-to-many relation is defined between the pmcy_compound entity 59 and the expt_goupresult entity 60. A one-to-many relation is defined between the pmcy_compoundlot entity 58 and the expt_groupresult entity 60.

An optional one-to-many relation is defined between the expt_groupresult entity 60 and an expt_conresult entity 61. The expt_conresult entity 61 lists results at a lower description level, i.e. inhibition of a analyte A's activity at a defined concentration. A one-to-many relation is defined between the expt_group entity 48 and the expt_conresult entity 61. An optional one-to-many relation is defined between the expt_conresult entity 61 and an expt_wellresult entity 62. The expt_wellresult entity 62 lists results related to a specific well. An expt_plate entity 62 bis is defined via a one-to-one relation to the pmcy_plate entity 55. A one-to-many relation is defined between the expt_plate entity 62 bis and the expt_wellresult entity 62. The expt_plate entity 62 bis is related to itself in a one-to-many relation. This is to model the location of the plates of the controls which may be stored on another physical support.

A pmcy_robot entity 63 lists the robots available in the high throughput laboratory. A one-to-many relation is defined between the pmcy_robot entity 63 and a pmcy_robot_run entity 64. The pmcy_robot_run entity 64 lists the runs or steps to be made by a specific robot. A many-to-many relation is defined between the pmcy_robot_run entity 64 and the gdef_well entity 54 through a pmcy_robot_move entity 65. The pmcy_robot_move entity 65 lists the robot-moves per well to be performed in a single robot_run. A one-to-many relation is defined between the pmcy_robot_run entity 64 and a pmcy_robot_runstatus entity 66. The pmcy_robot_runstatus entity 66 lists the different statuses of a robot-run.

Database Contents

The content of the entities introduced above will now be presented in greater detail. Each entity includes multiple instances, with each instance having multiple fields.

Experiment entity 43 includes one instance for each experiment run. An experiment id field is the primary key holding a unique identifier for each experiment. Each experiment comprises information about cell-based assays, experiment date, people who performed the experiment, the screening platform used, information about the virus stock and the cell stock.

A protocol id field identifies the protocol used for the experiment as listed in the protocol entity 46. Each protocol further comprises information about the plate-size and quality control.

An assay id field identifies the assay used in the experiment as listed in the assay entity 44. Each assay further comprises information about the assay-type, the guest strain, the host strain, the mechanism and the target B.

Each experiment comprises a number of assays listed in the assays in experiment entity 45, whereby each assay within an experiment has an assay sequence and an id field. The assays within an experiment according to one protocol are listed in the protocol item entity 47 and identified by an id field.

Database Operational Example

In operation, the database is updated during the various processes. An example illustrates the interaction between the database and the processes.

For each assay to be tested an instance is added to the assay entity 44 identifying the assay.

For each protocol to be executed an instance is added to the protocol entity 46 identifying the protocol.

When an experiment is set up, an instance is added to the experiment entity 43 identifying the experiment. When an experiment is done according to a protocol, the experiment instance comprises an identifier for said protocol.

For each assay within the experiment an instance is added to the assays in experiment entity 45, and linked accordingly to said assay instance within the assay entity 44 and said experiment instance within the experiment entity 43.

An instance of a plate entity 52 is added for each physical support having a number of columns and a number of rows. For each row-column position within the plate instance, a well instance is created within the well entity 54, identifying a single row-column position.

For each compound within the compounds stock or pharmacy, an instance is added to the compound entity 59, identifying the compound.

Each compound-lot results in an instance added within the compound-lot entity 58 identifying the exact lot for said compound.

For each physical support applied with compounds, an instance is added to the plate entity 55. For each analyte Applied on the plate, an instance is added to the solute entity 57, identifying the solute and linked to the compound-lot. The solute instance further comprises an optional well field. The well field identifies the position on the plate where the compound was applied.

For each schema of plates, an instance is added to the schema entity 50. For each group of schemas, an instance is added to the group entity 49. For each plate within a schema an instance is added to the platesinschema entity 53, further identifying a plate sequence. For each schema within a group an instance is added to the schemasingroup entity 51, further identifying a schema sequence.

For each experiment various plates are used. For each schema of physical supports applied with compounds, an instance is added to the schema entity 56. For each group of physical supports applied with compounds, an instance is added to the group entity 48. The plate instance of plate entity 55 is further identified by a schema field, identifying the schema the plate belongs to. The schema instance of schema entity 56 is further identified by a group field, identifying the group the schema belongs to. The group instance of entity 48 is further identified by an experiment field, identifying the experiment the group belongs to.

For each robot within the high throughput process, an instance is added to the robot entity 63. An example of a robot is the plate design and filler system 11. Another example of a robot is the phase applier system 13. Another example of a robot is the detection system 15.

Each robot performs robot-runs. For each robot-run an instance is added to the robot-run entity 64, identified by an id field and the robot to perform the run on. An example of a robot-run is applying a target B onto the wells of a physical support.

Each robot-run comprises multiple robot-moves. For each robot-move an instance is added to the robot-move entity 65, identified by an id and a robot-run to be performed in. A robot-move instance further comprises a reference to a well instance within the well entity 54. Each robot-move corresponds to a set of instructions to perform the robot-move, for example apply analyte A in a well or apply target B in a well.

For each robot-run, several instances are added to a robot-run status entity 66, identified by an id field and a reference to a robot-run instance within the robot-run entity 64.

For each detection of an AB interaction, by means of a microscope, and for each well on a plate, an instance is added to a wellresult entity. When results are calculated, an instance is added to a conresult entity for each compound in a group, averaging the wellresult of a compound in a group, and an instance to the groupresults entity for each compound in a group.

For each instance within the conresult entity 61, instances may be added to a well result entity 62. An instance added to the expt_plate entity 62 bis defines the plate where the wells belong to.

In a preferred embodiment, the logical model is physically also modeled in one database.

The data model can readily be extended with other entities modeling additional robots involved within the high throughput process.

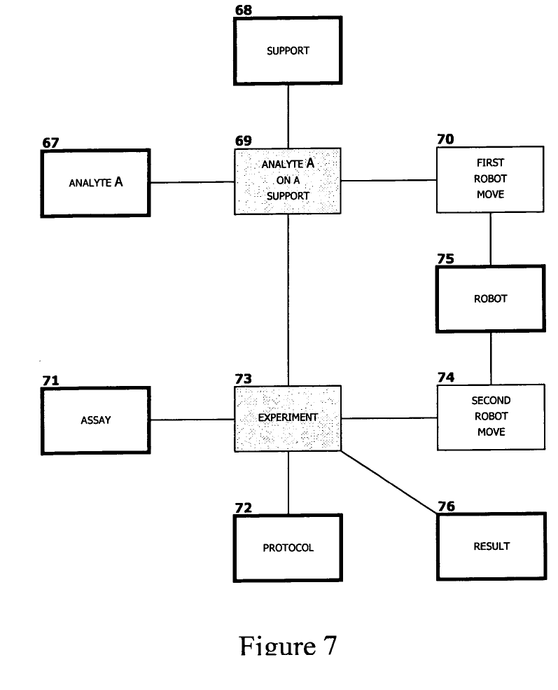

FIG. 7 is a logical model according to the present invention. The cardinality of the relationships is not shown in this model.

The analyte A entity 67 corresponds to the compounds entities 57-59 of FIG. 6. The support entity 68 corresponds to the physical support entities 49-54. The analyte A on a support entity 69 corresponds to the entities 48, 55 and 56.

The target B entity 71 corresponds to the assay entity 44. The protocol entity 72 corresponds to the assay-protocol entity 46. The experiment entity 73 corresponds to the experiment entity 43 of FIG. 6.

The robot-move and robot entities 70, 74 and 75 correspond to the robot entities 63-66.

Data mining involves reducing large amounts of information into manageable categories or so-called clusters. Mining can visualize complex relationships, relationships between compounds, but also relationships between experiments. Important hereby is to exclude errors and biasing factors, so that these do not interfere with the true relationships between dependent measures. The cost of high throughput screening is too high for conclusions to be made on the basis of erroneous observations, leading to confusion in subsequent experimenting.

The present invention therefore aims at maximum knowledge management of the complete process of high throughput, from start to beginning, in order to exclude errors and biases as much as possible. An experiment performed on a Monday might be less reliable than an experiment performed in the middle of a week for example. It may seem that experiments performed by certain people have a higher error rate than the average experiment for example. Environment conditions can also influence experiments in a positive or negative way. By measuring these conditions at real-time and storing them, the experiment result validation can incorporate this information in determining the reliability of an experiment. Similar experiments performed on different robots in a multi-robot environment can have different error rates, thus concluding that maybe some robot is not functioning correctly. All these are examples of the importance of modeling and storing information about the process as a whole in the validation process of experiments.

Using SQL (Standard Query Language) the database is queryable as is standard for all Oracle applications for example.

An SQL select operation involves selecting those instances from one or more entities satisfying certain conditions, for example, list the ids of the instances within the compound-lot entity 58 involving a certain lot sequence.

An SQL join operation involves joining the instances of two or more entities by means of their primary and foreign keys, possibly satisfying certain conditions. For example, list all experiments together with the assays involved, the protocol involved and the result involved.

Being modeled in one logical database, the process as a whole is queryable in this way. It is possible for example to join an experiment with its related protocol, its related assays, its related physical support, its related compounds, its related robot-moves and its related results. Another example involves the previous example further joined with a certain well on a certain physical support. In this way it is possible to extract all data relevant to the testing of one specific AB interaction.

The data mining or query facilities are made available to the scientist using an SQL user interface, for example commonly provided by Oracle.

The result entities 60, 61 and 62 are the link between the experiment results and the rest of the high throughput process modeled and stored in the database. Experiment results further comprise image files and other processed data, not necessarily stored in the database, but stored in a filing system or derived using algorithms at the time the data is needed. The database link via the experiment result entities allows for consulting the experiment results related to the entire process, in combination with resulting images of the experiment and other processed data stored outside the database.

In one embodiment an instance of the plate entity 55 is joined with the corresponding instances of the wellresult entity 62, whereby each wellresult instance is outputted as an image comprised in an image file and accordingly linked to the well result instance.

In one embodiment, an image file comprises an image of a well after compound interaction.

In a preferred embodiment, an image file comprises an image of a portion of an interaction taking place in a well.

The way the experiment images are obtained is not of any relevance to the present invention. Images can for example be scanned by means of an auto-focussed microscope coupled to a video camera. The microscope can be further equipped with a scanning stage to fit all array configurations and equipped with a stepper motor to scan each well or a portion of a well.

A next step, in a preferred embodiment, comprises the use of automated image analysis means to analyse the image. In relation to cell-based assays, image analysis means are used to determine the individual cells within the image. Analyzing an average of 70 cells out of 2000 gives a reliable result.

A dedicated user interface as represented in FIG. 8 gives access to database information as well as non-database information, directly or indirectly linked to database items. The object of the present invention is that via this user interface knowledge is acquired relating to the entire high throughput process as a whole, not solely concentrating on array analysis, whereby all data about this process is stored in a database or directly or indirectly linked to the database.

The images are displayed in a matrix corresponding to the column and row positions of said wells. Each image is a microscopic image of an AB interaction, or an area of such an interaction. The matrix as a whole represents a physical test-plate.

Each individual image within the matrix is color-coded according to the intensity of an AB interaction. By clicking on the matrix, database information is directly made available about the experiment.

By clicking on an individual image, database information is directly made available about the interaction taking place in that particular position in the form of, for instance, a graph, a table or a chemical structure of an analyte A.

In a preferred embodiment, the images are displayed on a web browser, allowing authorized access to all on the intranet and on the extranet. The web browser furthermore allows authorized access to the computer system 1, allowing high throughput data mining and control of the high throughput processes. The result of the data reporting can be exported into a specified output format, for example MS Excel and TIFF image files. Customers can also request tailor-made formats.

Reporting is easily done by extracting the necessary information from the database by commonly used database reporting tools, such as Oracle Discoverer for example, whereby reports can further be exported into an MS Excel format, and other non-database information can be added to the report.

The examples and embodiments described herein are for illustrative purposes only and various modifications or changes in light thereof will be suggested to persons skilled in the art and are to be included within the spirit and purview of this application and scope of the appended claims. For example, concerning the database, entities may be deleted, contents of multiple entities may be consolidated, or contents of one or more entities may be distributed among more entities than described herein to improve query speeds or to aid system maintenance. For example, concerning the user interface to be linked with the database, certain items may not be present.

1. A computer-implemented method for managing information relating to a high throughput process modeled in one logical database, said method comprising the steps of:
a) creating, in any order,
(i) instances for a analyte A entity, whereby said entity comprises a analyte A identifier,
(ii) instances for a support entity, whereby said entity comprises a support identifier,
(iii) instances for an assay entity, whereby said entity comprises an assay identifier,
(iv) instances for a protocol entity, whereby said entity comprises a protocol identifier,
b) creating
(i) instances for a analyte A on a first support entity, whereby said entity comprises a analyte A on support identifier, the analyte A identifier, the support identifier and a coordinate identifier,
(ii) instances for a first robot move entity, whereby said entity comprises the analyte A on support identifier, and
c) creating
(i) instances for an experiment entity, whereby said entity comprises an experiment identifier, the assay identifier, the analyte A on support identifier and the protocol identifier, whereby said experiment entity comprises instances whereby the analyte A entity is related to the assay entity, and
(ii) instances for a second robot move entity, whereby said entity comprises the experiment identifier.

2. The method according to claim 1, whereby the steps a)(i) and b) are iterated after step b) on a second support entity.

3. The method according to claim 1 or 2, whereby the assay entity comprises instances for a target B entity, whereby said target B entity comprises a target B identifier.

4. The method according to claim 1, 2 or 3 whereby the instances for an experiment entity are created by
a) first creating an entity comprising an identifier for said entity, the analyte A on a support identifier and the protocol identifier, and
b) then, creating the experiment entity comprising the experiment identifier, the identifier for the entity created in step a), and an assay identifier; and
whereby the instances for a second robot move entity involve the application of target B as defined within the assay identifier, on the analyte A on the support as defined in the analyte A on a support identifier.

5. The method according to any one of claims 1 to 4, whereby the analyte A on a support entity comprises instances whereby one analyte A entity is related to a plurality of support entities, and/or whereby one support entity is related to a plurality of analyte A entities.

6. The method according to any one of claims 1 to 5, whereby the analyte A on a support entity comprises instances whereby one coordinate of a support entity is related to one or more assays.

7. The method according to any one of claims 1 to 6, whereby the experiment entity comprises instances whereby one assay entity is related to a plurality of analytes A on support entities, and/or whereby one analyte A on a support entity is related to a plurality of assay entities.

8. The method according to any one of claims 1 to 7, whereby the experiment entity comprises instances whereby one assay entity is related to one or more protocol entities, and/or whereby one protocol entity is related to one or more assay entities.

9. The method according to any one of claims 1 to 8, further comprising the step of creating instances for a further robot entity, whereby said entity comprises a robot identifier.

10. The method according to any one of claims 1 to 9, further comprising the step of creating instances for a result entity, whereby said entity comprises a result identifier and the experiment identifier.

11. The method according to any one of claims 1 to 10, whereby a reporting facility is able to report the result instances for one support identifier with the corresponding instance(s) from the:
a) experiment entity,
b) protocol entity,
c) analyte A entity and assay entity,
d) analyte A and assay on a support entity,
e) support entity or support entities,
f) robot move entity or robot move entities,
g) robot entity or robot entities,
whereby the process as a whole is accessible.

12. The method according to claim 11, whereby the reporting facility reports one or more result instances for one support identifier and one coordinate identifier.

13. The method according to claim 11 or 12, whereby the result instances corresponding to one support identifier are visually displayed as images in a matrix corresponding to the support, each of which corresponds to its coordinate within the support, whereby said visual display further allows access to data related to the visually displayed result instances.

14. The method according to claim 13, whereby the images are color-coded.

15. The method according to any one of claims 1 to 14, whereby the target B entity in the assay entity is a biological target comprising cells.

16. The method according to claim 15, whereby the result data are cell based result data.

17. The method according to any one of claims 1 to 16, whereby the database and the database reporting facilities are accessible via a web browser.

18. The method according to any one of claims 1 to 17, performed on one or more robots comprising means for:
a) dispensing small volumes of a target A entity on a support entity,
b) adding a target B entity onto the target A entity on the support entity and allowing interaction between analyte A and target B,
c) detecting analyte A+target B interaction result, and
d) reporting the detected result.

19. The method according to claim 18, whereby a robot comprises means for multiplying a first support entity comprising 96 coordinates for target A to a second support entity preferably comprising 384, 1536, or 9600, or any other multiplicand of 96 target A coordinates.

20. A data processing system comprising means for carrying out the steps of the method according to any one of claims 1 to 19.

21. A computer program comprising program code means adapted to carry out the method according to any one of claims 1 to 19 when run on a computer.

22. A computer readable medium comprising program code adapted to carry out the method according to any one of claims 1 to 19 when run on a computer.

23. A high throughput screening system comprising a computer system and a robot device capable of performing said high throughput screening, wherein the method according to any one of claims 1 to 19 is implemented.

24. The high throughput screening system according to claim 23 wherein the robot device comprises means for:
a) dispensing a analyte A on a support,
b) dispensing a target B on the support,
c) allowing interaction between the analyte A and target B,
d) detecting the interaction between the analyte A and target B.

25. The high throughput screening system according to claim 23, wherein first and second dispensing means for a analyte A are provided, said first dispensing means are able to dispense analyte A on a support having 96 coordinates and said second dispensing means are able dispense the analyte A from the 96 coordinates support to a second support entity having 384, 1536, or 9600, or any other multiplicand of 96 coordinates.

26. The high throughput screening system according to any one of claims 23 to 25 wherein the dispensing means for a target B comprises means for dispensing the target B over the targets A on a support in a continuous movement.

27. The high throughput screening system according to any one of claims 23 to 26 wherein the detection means comprises an auto-focussing microscope.

28. The high throughput screening system according to any one of claims 23 to 27 wherein the computer system comprises output means for outputting a report obtained via the method of claims 1 to 19.

29. The high throughput screening system according to any one of claims 23 to 28 having a dimension such that it is transportable over public traffic roads.

30. A reporting system for the high throughput screening system of claims 23 to 28, comprising means for reporting high throughput screening interaction results.
